(19) United States
(12) Patent Application Publication
(10) Pub. No.: US 2015/0337088 A1
(43) Pub. Date: Nov. 26, 2015

(54) Substrate In Powder Or Fiber Form

(71) Applicant: Dow Corning Corporation, Midland, MI (US)

(72) Inventors: Pierre Chevalier, Lille (FR); Francois De Buyl, Hoeilaart (BE); Scott Miller, Freeland, MI (US); Christophe Paulo, Nivelles (BE); Vincent Rerat, Tubize (BE)

(21) Appl. No.: 14/377,269

(22) PCT Filed: Jan. 31, 2013
(86) PCT No.: PCT/EP2013/051965

§ 371 Date: Aug. 7, 2014

Related U.S. Application Data
(60) Provisional application No. 61/596,287, filed on Feb. 8, 2012.

(51) Int. Cl. C08J 3/20; C09C 3/12; C08J 7/04; C08L 27/18; C08L 23/12; C08L 83/04; C08L 63/00; C09C 3/10; C08K 9/06

(52) U.S. Cl. CPC C08J 3/203; C09C 3/10; C09C 3/12; C08J 7/047; C08K 9/06; C08L 23/12; C08L 83/04; C08L 63/00; C08L 27/18; C08L 2201/02; C08L 2205/03

(57) ABSTRACT

The invention provides a substrate in powder or fibre form whose surface is treated with a silicone compound, characterised in that the surface has been treated with an emulsion containing the silicone compound, water and a ethylene oxide/propyl ene oxide block copolymer.

### BACKGROUND OF THE INVENTION

The treatment of fillers with high Mw silicone-based materials is still a challenge in the thermoplastic/rubber industry due to the difficulty to handle viscous, high Molecular weight silicones.

It is known to treat fillers like silica with silicone gums but the technique require high shear methods, which is difficult to put in place and also not cost effective.

Classical fillers surface treatments are known but they are often using solvent based solutions. The development of an aqueous solution based method to surface treat fillers would represent a huge “plus” on an environmental aspect.

Classical surface treatment of fillers is based on stearic based molecules. This treatment is cost effective but performances improvement of the final composite will not achieve the same level of improvement compared to silicone polymers based surface treatments.

It is desirable to provide a substrate in powder or fibre form whose surface is treated with a silicone compound.

There is a need to provide a substrate in powder or fibre form bearing silicone on its surface produced by a solventless process.

### BRIEF SUMMARY OF THE INVENTION

The present inventors have discovered that a substrate in powder or fibre form whose surface is treated with a silicone compound can be obtained by treating the surface with an emulsion containing the silicone compound, water and a ethylene oxide/propylene oxide block copolymer.

The invention further provides a process for forming a surface treated substrate in powder or fibre form comprising applying an emulsion comprising a silicone compound, an ethylene oxide/propylene oxide block copolymer and water onto the surface of the substrate.

The invention extends to a method of improving mechanical, optical, processing, or flame retardancy of a matrix by incorporating into the matrix a substrate in powder form whose surface has been treated with an emulsion comprising a silicone compound, water and a ethylene oxide/propylene oxide.

The invention also provides the use of an emulsion comprising a silicone compound, water and an ethylene oxide/propylene oxide block copolymer to treat the surface of a substrate in powder or fibre form.

### DETAILED DESCRIPTION OF THE INVENTION

Preferably, the substrate is a filler, fibre, pigment, metallic or mineral powder. Examples of mineral filler which can be treated according to the invention include titanium dioxide, aluminum trihydroxide (also called ATH), magnesium dihydroxide (MGH), mica, kaolin, calcium carbonate, non-hydrated, partially hydrated, or hydrated fluorides, chlorides, bromides, iodides, chromates, carbonates, hydroxides, phosphates, hydrogen phosphates, nitrates, oxides and sulphates of sodium, potassium, magnesium, calcium and barium: zinc oxide, aluminum oxide, antimony pentoxide, antimony trioxide, beryllium oxide, chromium oxide, iron oxide, lithopone, boric acid or a borate salt such as zinc borate, barium metaborate or aluminium borate, mixed metal oxides such as aluminosilicate, vermiculite, silica including fumed silica, fused silica, precipitated silica, quartz, sand, glass powder, silica gel; rice hull ash, ceramic and glass beads, zeolites, metals such as aluminium flakes or powder, bronze powder, copper, gold, molybdenum, nickel, silver powder or flakes, stainless steel powder, tungsten, hydrous calcium silicate, barium titanate, silica-carbon black composite, carbon black, functionalized carbon nanotubes, cement, fly ash, slate flour, bentonite, clay, talc anthracite, apatite, attapulgite, boron nitride, cristobalite, diatomaceous earth, dolomite, ferrite, feldspar, graphite, calcined kaolin, molybdenum disulfide, perlite, pumice, pyrophyllite, sepiolite, zinc stannate, zinc sulphide or wollastonite. It can be a mineral filler like Hyperform filler from Milliken belonging to the Magnesium Oxy-Sulfate family. It can be wood flour, wood fibres, cellulose and cellulose-containing products, aramid fibres, nylon fibres, cotton fibres, or glass fibres.

In a preferred embodiment, the substrate is an organic powder or fibre, preferably a polymer like tetrafluoroethylene or powdery polypropylene.

Surface treatment of the fillers with silicone based materials through this new technique will afford new advantages like:

Improvement of mechanical performances through a better filler dispersion within the Plastic/Rubber matrix but also through a better compatibilization of the fillers with the host matrix.

This treatment allows also to bring the classical performances related to silicones to the final compound like the anti-scratch resistance, better surface appearance, flame retardancy improvement/synergy, better optical performances (for TiO2 dispersion in clear matrices for examples, this is more on an application in light emitting devices).

Moreover, this new technique of surface treatment will give an easy access to compounder to produce silicone/polymer Master Batches where the filler would be used as a carrier for the silicone. This new technology gives the opportunity to offer new “powdery silicones” for the Masterbatch market.

The different polymeric matrices are thermoplastics, blends of thermoplastics/rubbers and any blends of thermoplastics with rubbers.

Amongst thermoplastic matrices one can find polyolefins like polypropylene, polyethylene, polyesters like polyethyleneterephtalate (PET) or polybutyleneterephtalate (PBT), carbonates like polycarbonate (PC), biosources polymers like polylactid acid (PLA), polyhydroxyalcanoate (PHA), polymamides. Rubbers are based styrenic polymers like ABS for example. Any polymer blends like PC/ABS or PC/PBT for instance.

Preferably, the silicone compound is functionalized. Preferably, the silicone compound contains hydroxyl, amino, unsaturations or alkoxy functions. In other preferred embodiments, the silicone compound contains acryloxy, methacryloxy, glycidoxy, vinyl or allyl functions.

The organic functions beard by the silicone compound can be pendant along the polysiloxane chain or they can be terminal.

The silicone compound can be a PDMS of high or low molecular weight, a T resin or a Q resin, an MDT, TQ or MQ resin.

The treated substrate in powder or fibre form can bring on a matrice properties classically provided by silicones i.e. thermal stability, optical properties, anti-scratch, releasing agent, process aid.

Preferably, the silicone compound is a silicone gum or a silicone resin. Preferably, the silicone compound has a kinetic viscosity greater than one million cSt at 25° C. Preferably, the silicone compound is polydimethylsiloxane having a viscosity of at least 500 thousand cP at 0.01 Hz at 25° C.

Preferably, the ethylene oxide/propylene oxide block copolymer is a poly(oxyethylene)-poly(oxypropylene)-poly(oxyethylene) tri-block copolymer having the formula;

HO(CH₂CH₂O)ₘ(CH₂CH(CH₃)O)ₙ(CH₂CH₂O)ₘH

where;

m may vary from 50 to 400, and

n may vary from 20 to 100.

Preferably, the ethylene oxide/propylene oxide block copolymer is a tetrafunctional poly(oxyethylene)-poly(oxypropylene) block copolymer having the average formula;

[HO(CH₂CH₂O)_{q}(CH₂CH(CH₃)O)ᵣ]₂NCH₂CH₂N[(CH₂CH(CH₃)O)ᵣ(CH₂CH₂O)_{q}H]₂

where;

q may vary from 50 to 400, and

r may vary from 15 to 75.

Preferably the matrix is a thermoplastics, thermoset, rubber or a mixture of these.

Preferably, the silicone containing emulsion is prepared as follows:
I) forming a dispersion of;
   A) 100 parts of a silicone compound,
   B) 5 to 100 parts of a ethylene oxide/propylene oxide block copolymer,
II) admixing a sufficient amount of water to the dispersion from step I) to form an emulsion,
III) optionally, further shear mixing the emulsion.

As used herein, “parts” refers to parts by weight.

### A1) The Silicone Gum

Component A) can be a silicone gum. “Silicone gum” as used herein refers to predominately linear organopolysiloxanes having sufficiently high molecular weight (Mw) to provide kinetic viscosities greater than 500 thousand cSt at 25° C. While any organopolysiloxane considered as a gum may be selected as component (A), typically the silicone gum is a diorganopolysiloxane gum with a molecular weight sufficient to impart a William's plasticity number of at least about 30 as determined by the American Society for Testing and Materials (ASTM) test method 926. The silicon-bonded organic groups of the diorganopolysiloxane may independently be selected from hydrocarbon or halogenated hydrocarbon groups. These may be specifically exemplified by alkyl groups having 1 to 20 carbon atoms, such as methyl, ethyl, propyl, butyl, pentyl and hexyl; cycloalkyl groups, such as cyclohexyl and cycloheptyl; aryl groups having 6 to 12 carbon atoms, such as phenyl, tolyl and xylyl; aralkyl groups having 7 to 20 carbon atoms, such as benzyl and phenylethyl; and halogenated alkyl groups having 1 to 20 carbon atoms, such as 3,3,3-trifluoropropyl and chloromethyl. Thus, diorganopolysiloxane can be a homopolymer, a copolymer or a terpolymer containing such organic groups. Examples include homopolymers comprising dimethylsiloxy units, homopolymers comprising 3,3,3-trifluoropropylmethylsiloxy units, copolymers comprising dimethylsiloxy units and phenylmethylsiloxy units, copolymers comprising dimethylsiloxy units and 3,3,3-trifluoropropylmethylsiloxy units, copolymers of dimethylsiloxy units and diphenylsiloxy units and interpolymers of dimethylsiloxy units, diphenylsiloxy units and phenylmethylsiloxy units, among others.

The silicon-bonded organic groups of the diorganopolysiloxane may also be selected from alkenyl groups having 1 to 20 carbon atoms, such as vinyl, allyl, butyl, pentyl, hexenyl, or dodecenyl. Examples include; dimethylvinylsiloxy-endblocked dimethylpolysiloxanes; dimethylvinylsiloxy-endblocked dimethylsiloxane-methylvinylsiloxane copolymers; dimethylvinylsiloxy-endblocked methylphenylpolysiloxanes; dimethylvinylsiloxy-endblocked methylphenylsiloxane-dimethylsiloxane-methylvinylsiloxane copolymers.

The silicon-bonded organic groups of the diorganopolysiloxane may also be selected from various organofunctional groups such as amino, amido, mercapto, or epoxy functional groups.

The molecular structure is also not critical and is exemplified by straight-chain and partially branched straight-chain structures, the linear systems being the most typical.

The silicone gum used as component A) may also be a combination or mixture of any of the aforementioned polydiorganosiloxanes.

In one embodiment, the silicone gum is a hydroxy terminated polydimethylsiloxane gum having a viscosity of at least 20 million cP at 25° C. at 0.01 Hz.

The silicone gum may be used in combination with other organopolysiloxanes. Organopolysiloxanes are polymers containing siloxane units independently selected from (R₃SiO_{1/2}), (R₂SiO_{2/2}), (RSiO_{3/2}), or (SiO_{4/2}) siloxy units, where R may be any monovalent organic group. When R is a methyl group in the (R₃SiO_{1/2}), (R₂SiO_{2/2}), (RSiO_{3/2}), or (SiO_{4/2}) siloxy units of an organopolysiloxane, the siloxy units are commonly referred to as M, D, T, and Q units respectively. These siloxy units can be combined in various manners to form cyclic, linear, or branched structures. The chemical and physical properties of the resulting polymeric structures can vary. For example organopolysiloxanes can be volatile or low viscosity fluids, high viscosity fluids/gums, elastomers or rubbers, and resins depending on the number and type of siloxy units in the average polymeric formula. R may be any monovalent organic group, alternatively R is a hydrocarbon group containing 1 to 30 carbons, alternatively R is an alkyl group containing 1 to 30 carbon atoms, or alternatively R is methyl.

The amount of the additional organopolysiloxane combined with the silicone gum may vary. Typically, 0.1 parts to 1000 parts by weight, alternatively 0.1 to 100 parts by weight of the additional organopolysiloxane is added for every 100 parts of the silicone gum.

In one embodiment, the silicone gum is combined with an aminofunctional organopolysiloxane. The aminofunctional organopolysiloxanes may be characterized by having at least one of the R groups in the formula RₙSiO_{(4-n)/2} be an amino functional group. The amino functional group may be present on any siloxy unit having an R substituent, that is, they may be present on any (R₃SiO_{1/2}), (R₂SiO_{2/2}), or (RSiO_{3/2}) unit, and is designated in the formulas herein as R^{N}. The amino-functional organic group R^{N} is illustrated by groups having the formula; R³NHR⁴, R³NR₂⁴, or R³NHR³NHR⁴, wherein each R³ is independently a divalent hydrocarbon group having at least 2 carbon atoms, and R⁴ is hydrogen or an alkyl group. Each R³ is typically an alkylene group having from 2 to 20 carbon atoms. R³ is illustrated by groups such as; —CH₂CH₂—, —CH₂CH₂CH₂—, —CH₂CHCH₃—, —CH₂CH₂CH₂CH₂—, —CH₂CH(CH₃)CH₂—, —CH₂CH₂CH₂CH₂CH₂—, —CH₂CH₂CH₂CH₂CH₂CH₂—, —CH₂CH₂CH(CH₂CH₃)CH₂CH₂CH₂—, —CH₂CH₂CH₂CH₂CH₂CH₂CH₂CH₂—, and —CH₂CH₂CH₂CH₂CH₂CH₂CH₂CH₂CH₂CH₂—. The alkyl groups R⁴ are as illustrated above for R. When R⁴ is an alkyl group, it is typically methyl.

Some examples of suitable amino-functional hydrocarbon groups are; —CH₂CH₂NH₂, —CH₂CH₂CH₂NH₂, —CH₂CH(CH₃)NH₂, —CH₂CH₂CH₂CH₂NH₂, —CH₂CH₂CH₂CH₂CH₂NH₂, —CH₂CH₂CH₂CH₂CH₂CH₂NH₂, —CH₂CH₂NHCH₃, —CH₂CH₂CH₂NHCH₃, —CH₂CH(CH₃)CH₂NHCH₃, —CH₂CH₂CH₂CH₂NHCH₃, —CH₂CH₂NHCH₂CH₂NH₂,—CH₂CH₂CH₂NHCH₂CH₂NH₂, —CH₂CH₂CH₂NHCH₂CH₂CH₂NH₂, —CH₂CH₂CH₂CH₂NHCH₂CH₂CH₂CH₂NH₂, —CH₂CH₂NHCH₂CH₂NHCH₃, —CH₂CH₂CH₂NHCH₂CH₂CH₂NHCH₃, —CH₂CH₂CH₂CH₂NHCH₂CH₂CH₂CH₂NHCH₃, and —CH₂CH₂NHCH₂CH₂NHCH₂CH₂CH₂CH₃.

Alternatively, the amino functional group is—CH₂CH(CH₃)CH₂NHCH₂CH₂NH₂

The aminofunctional organopolysiloxane used in combination with the silicone gum may be selected from those having the average formula;

[R₃SiO₁₂][R₂SiO_{2/2}]ₐ[RR^{N}siO_{2/2}]_{b}[R₃SiO_{1/2}]

where;
a is 1-1000, alternatively 1 to 500, alternatively 1 to 200,
b is 1-100, alternatively 1 to 50, alternatively 1 to 10,
R is independently a monovalent organic group,
alternatively R is a hydrocarbon containing 1-30 carbon atoms,
alternatively R is a monovalent alkyl group containing 1-12 carbons, or
alternatively R is a methyl group;
R^{N} is as defined above.

The aminofunctional organopolysiloxane used I combination with the silicone gum may also be a combination of any of the aforementioned aminofunctional organopolysiloxanes.

### A2) The Silicone Resin

Component A) can be a silicone resin. As used herein, “silicone resin” refers to any organopolysiloxane containing at least one (RSiO_{3/2}), or (SiO_{4/2}) siloxy unit. Organopolysiloxanes are polymers containing siloxy units independently selected from (R₃SiO_{1/2}), (R₂SiO_{2/2}), (RSiO_{3/2}), or (SiO_{4/2}) siloxy units, where R may be any organic group. These siloxy units are commonly referred to as M, D, T, and Q units respectively. These siloxy units can be combined in various manners to form cyclic, linear, or branched structures. The chemical and physical properties of the resulting polymeric structures vary depending on the number and type of siloxy units in the organopolysiloxane. “Linear” organopolysiloxanes typically contain mostly D or (R₂SiO_{2/2}) siloxy units, which results in polydiorganosiloxanes that are fluids of varying viscosity, depending on the “degree of polymerization” or DP as indicated by the number of D units in the polydiorganosiloxane. “Linear” organopolysiloxanes typically have glass transition temperatures (T_{g}) that are lower than 25° C. “Resin” organopolysiloxanes result when a majority of the siloxy units are selected from T or Q siloxy units. When T siloxy units are predominately used to prepare an organopolysiloxane, the resulting organosiloxane is often referred to as a “silsesquioxane resin”. When M and Q siloxy units are predominately used to prepare an organopolysiloxane, the resulting organosiloxane is often referred to as a “MQ resin”. Alternatively, the formula for an organopolysiloxane may be designated by the average of the siloxy units in the organopolysiloxane as follows; RₙSiO_{(4-n)/2}, where the R is independently any organic group, alternatively a hydrocarbon, or alternatively an alkyl group, or alternatively methyl. The value of n in the average formula may be used to characterize the organopolysiloxane. For example, an average value of n=1 would indicate a predominate concentration of the (RSiO_{3/2}) siloxy unit in the organopolysiloxane, while n=2 would indicate a predominance of (R₂SiO_{2/2}) siloxy units. As used herein, “organopolysiloxane resin” refers to those organopolysiloxanes having a value of n less than 1.8 in the average formula RₙSiO_{(4-n)/2}, indicating a resin.

The silicone resin useful as component A2) may independently comprise (i) (R¹₃SiO_{1/2})ₐ, (ii) (R²₂SiO_{2/2})_{b}, (iii) (R³SiO_{3/2})_{c}, and (iv) (SiO_{4/2})_{d} siloxy units, providing there is at least one T or Q siloxy unit in the silicone resin molecule. The amount of each unit present in the silicone resin is expressed as a mole fraction (i.e. a, b, c, or d) of the total number of moles of all M, D, T, and Q units present in the silicone resin. Any such formula used herein to represent the silicone resin does not indicate structural ordering of the various siloxy units. Rather, such formulae are meant to provide a convenient notation to describe the relative amounts of the siloxy units in the silicone resin, as per the mole fractions described above via the subscripts a, b, c, and d. The mole fractions of the various siloxy units in the present organosiloxane block copolymers, as well as the silanol content, may be readily determined by ²⁹Si NMR techniques.

The silicone resin may also contain silanol groups (≡SiOH). The amount of silanol groups present on the silicone resin may vary from 0.1 to 35 mole percent silanol groups [≡SiOH], alternatively from 2 to 30 mole percent silanol groups [≡SiOH], alternatively from 5 to 20 mole percent silanol groups [≡SiOH]. The silanol groups may be present on any siloxy units within the silicone resin.

The molecular weight of the silicone resin is not limiting. The silicone resin may have an average molecular weight (M_{w}) of at least 1,000 g/mole, alternatively an average molecular weight of at least 2,000 g/mole alternatively an average molecular weight of at least 5,000 g/mole. The average molecular weight may be readily determined using Gel Permeation Chromatography (GPC) techniques.

In one embodiment, the silicone resin is a MQ silicone. The silicone resin may be a MQ resin comprising at least 80 mole % of siloxy units selected from (R¹₃SiO_{1/2})ₐ and (SiO_{4/2})_{d} units (that is a+d≧0.8), where R¹ is an alkyl group having from 1 to 8 carbon atoms, an aryl group, a carbinol group, or an amino group, with the proviso that at least 95 mole % of the R¹ groups are alkyl groups, a and d each have a value greater than zero, and the ratio of a/d is 0.5 to 1.5.

The R¹ units of the MQ resin are independently an alkyl group having from 1 to 8 carbon atoms, an aryl group, a carbinol group, or an amino group. The alkyl groups are illustrated by methyl, ethyl, propyl, butyl, pentyl, hexyl, and octyl. The aryl groups are illustrated by phenyl, naphthyl, benzyl, tolyl, xylyl, xenyl, methylphenyl, 2-phenylethyl, 2-phenyl-2-methylethyl, chlorophenyl, bromophenyl and fluorophenyl with the aryl group typically being phenyl.

MQ resins suitable for use as component (A), and methods for their preparation, are known in the art. For example, U.S. Pat. No. 2,814,601 to Currie et al., Nov. 26, 1957, which is hereby incorporated by reference, discloses that MQ resins can be prepared by converting a water-soluble silicate into a silicic acid monomer or silicic acid oligomer using an acid. When adequate polymerization has been achieved, the resin is end-capped with trimethylchlorosilane to yield the MQ resin. Another method for preparing MQ resins is disclosed in U.S. Pat. No. 2,857,356 to Goodwin, Oct. 21, 1958, which is hereby incorporated by reference. Goodwin discloses a method for the preparation of an MQ resin by the cohydrolysis of a mixture of an alkyl silicate and a hydrolyzable trialkylsilane organopolysiloxane with water.

The MQ resins suitable as component A) in the present invention may contain D and T units. The MQ resins may also contain hydroxy groups. Typically, the MQ resins have a total weight % hydroxy content of 2-10 weight %, alternatively 2-5 weight %. The MQ resins can also be further “capped” wherein residual hydroxy groups are reacted with additional M groups.

In one embodiment, the silicone resin is a silsesquioxane resin. The silsesquioxane resin may be a silsesquioxane resin comprising at least 80 mole % of R³SiO_{3/2} units, where R³ in the above trisiloxy unit formula is independently a C₁ to C₂₀ hydrocarbyl, a carbinol group, or an amino group. As used herein, hydrocarbyl also includes halogen substituted hydrocarbyls. R³ may be an aryl group, such as phenyl, naphthyl, anthryl group. Alternatively, R³ may be an alkyl group, such as methyl, ethyl, propyl, or butyl. Alternatively, R³ may be any combination of the aforementioned alkyl or aryl groups. Alternatively, R³ is phenyl, propyl, or methyl. In one embodiment, at least 40 mole % of the R³ groups are propyl, referred herein as T-propyl resins, since the majority of the siloxane units are T units of the general formula R³SiO_{3/2} where at least 40 mole %, alternatively 50 mole %, or alternatively 90 mole % of the R³ groups are propyl. In another embodiment, at least 40 mole % of the R³ groups are phenyl, referred herein as T-phenyl resins, since the majority of the siloxane units are T units of the general formula R³SiO_{3/2} where at least 40 mole %, alternatively 50 mole %, or alternatively 90 mole % of the R³ groups are phenyl. In yet another embodiment, R³ may be a mixture of propyl and phenyl. When R³ is a mixture of propyl and phenyl, the amounts of each in the resin may vary, but typically the R³ groups in the silsesquioxane resin may contain 60-80 mole percent phenyl and 20-40 mole percent propyl.

Silsesquioxane resins are known in the art and are typically prepared by hydrolyzing an organosilane having three hydrolyzable groups on the silicon atom, such as a halogen or alkoxy group. Thus, silsesquioxane resins can be obtained by hydrolyzing propyltrimethoxysilane, propyltriethoxysilane, propyltripropoxysilane, or by co-hydrolyzing the aforementioned propylalkoxysilanes with various alkoxysilanes. Examples of these alkoxysilanes include methyltrimethoxysilane, methyltriethoxysilane, methyltriisopropoxysilane, dimethyldimethoxysilane, and phenyltrimethoxysilane. Propyltrichlorosilane can also be hydrolyzed alone, or in the presence of alcohol. In this case, co-hydrolyzation can be carried out by adding methyltrichlorosilane, dimethyldichlorosilane, phenyltrichlorosilane, or similar chlorosilanes and methyltrimethoxysilane, methyltriethoxysilane, methyltriisopropoxysilane, or similar methylalkoxysilane. Alcohols suitable for these purposes include methanol, ethanol, n-propyl alcohol, isopropyl alcohol, butanol, methoxy ethanol, ethoxy ethanol, or similar alcohols. Examples of hydrocarbon-type solvents which can also be concurrently used include toluene, xylene, or similar aromatic hydrocarbons; hexane, heptane, isooctane, or similar linear or partially branched saturated hydrocarbons; and cyclohexane, or similar aliphatic hydrocarbons.

The silsesquioxane resins suitable in the present disclosure may contain M, D, and Q units, but typically at least 80 mole %, alternatively 90 mole % of the total siloxane units are T units. The silsesquioxane resins may also contain hydroxy and/or alkoxy groups. Typically, the silsesquioxane resins have a total weight % hydroxy content of 2-10 weight % and a total weight % alkoxy content of up to 20 weight %, alternatively 6-8 weight % hydroxy content and up to 10 weight % alkoxy content.

Representative, non-limiting examples of commercial silicone resins suitable as component A) include; silicone resins sold under the trademarks DOW CORNING® 840 Resin, DOW CORNING® 2-7466 Resin, DOW CORNING® 2-9138 Resin, DOW CORNING® 2-9148 Resin, DOW CORNING® 2104 Resin, DOW CORNING® 2106 Resin, DOW CORNING® 217 Flake Resin, DOW CORNING® 220 Flake Resin, DOW CORNING® 233 Flake Resin, DOW CORNING® 4-2136 Resin, Xiameter® RSN-6018 Resin, Xiameter® RSN-0217 Resin, Silres® MK methyl silicone resin, Dow Corning® MQ 1600 Resin.

As used herein, “silicone resin” also encompasses silicone-organic resins. Thus, silicone-organic resins includes silicone-organic copolymers, where the silicone portion contains at least one (RSiO_{3/2}), or (SiO_{4/2}) siloxy unit. The silicone portion of the silicone-organic resin may be any of the silisesquioxane or MQ resins as described above. The organic portion may be any organic polymer, such as those derived by free radical polymerization of one or more ethylenically unsaturated organic monomers. Various types of ethylenically unsaturated and/or vinyl containing organic monomers can be used to prepare the organic portion including; acrylates, methacrylates, substituted acrylates, substituted methacrylates, vinyl halides, fluorinated acrylates, and fluorinated methacrylates, for example. Some representative compositions include acrylate esters and methacrylate esters such as methyl acrylate, ethyl acrylate, butyl acrylate, 2-ethylhexyl acrylate, methyl methacrylate, decyl acrylate, lauryl acrylate, isodecyl methacrylate, lauryl methacrylate, and butyl methacrylate; substituted acrylates and methacrylates such as hydroxyethyl acrylate, perfluorooctyl acrylate, hydroxypropyl acrylate, hydroxypropyl methacrylate, and hydroxyethyl methacrylate; vinyl halides such as vinyl chloride, vinylidene chloride, and chloroprene; vinyl esters such as vinyl acetate and vinyl butyrate; vinyl pyrrolidone; conjugated dienes such as butadiene and isoprene; vinyl aromatic compounds such as styrene and divinyl benzene; vinyl monomers such as ethylene; acrylonitrile and methacrylonitrile; acrylamide, methacrylamide, and N-methylol acrylamide; and vinyl esters of monocarboxylic acids

The silicone resin selected as component A) may also be a combination(s) of any of the aforementioned silicone resins.

### B) The Ethylene Oxide/Propylene Oxide Block Copolymer

Component B) is an ethylene oxide/propylene oxide block copolymer. Component B) may be selected from those ethylene oxide/propylene oxide block copolymers known to have surfactant behaviour. Typically, the ethylene oxide/propylene oxide block copolymers useful as component B) are surfactants having an HLB of at least 12, alternatively, at least 15, or alternatively at least 18.

The molecular weight of the ethylene oxide/propylene oxide block copolymer may vary, but typically is at least 4,000 g/mol, alternatively at least 8,000 g/mol, or at least 12,000 g/mol.

The amounts of ethylene oxide (EO) and propylene oxide (PO) present in the ethylene oxide/propylene oxide block copolymer may vary, but typically, the amount of EO may vary from 50 percent to 80 percent, or alternatively from 60 percent to about 85 percent, or alternatively from 70 percent to 90 percent.

In one embodiment, component B) is a poly(oxyethylene)-poly(oxypropylene)-poly(oxyethylene) tri-block copolymer. Poly(oxyethylene)-poly(oxypropylene)-poly(oxyethylene) tri-block copolymers are also commonly known as Poloxamers. They are nonionic triblock copolymers composed of a central hydrophobic chain of polyoxypropylene (poly(propylene oxide)) flanked by two hydrophilic chains of polyoxyethylene (poly(ethylene oxide)).

Poly(oxyethylene)-poly(oxypropylene)-poly(oxyethylene) tri-block copolymers are commercially available from BASF (Florham Park, N.J.) and are sold under the tradename PLURONIC®. Representative, non-limiting examples suitable as component (B) include; PLURONIC® F127, PLURONIC® F98, PLURONIC® F88, PLURONIC® F87, PLURONIC® F77 and PLURONIC® F68, and PLURONIC® F-108.

In a further embodiment, the poly(oxyethylene)-poly(oxypropylene)-poly(oxyethylene) tri-block copolymer has the formula;

HO(CH₂CH₂O)ₘ(CH₂CH(CH₃)O)ₙ(CH₂CH₂O)ₘH

where
the subscript “m” may vary from 50 to 400, or alternatively from 100 to 300, and
the subscript “n” may vary from 20 to 100, or alternatively from 25 to 100.

In one embodiment, component B) is a tetrafunctional poly(oxyethylene)-poly(oxypropylene) block copolymer derived from the sequential addition of propylene oxide and ethylene oxide to ethylene diamine. These tetra-functional block copolymers are also commonly known as Poloxamines. The tetrafunctional poly(oxyethylene)-poly(oxypropylene) block copolymer may have the average formula;

[HO(CH₂CH₂O)_{q}(CH₂CH(CH₃)O)ᵣ]₂NCH₂CH₂N[(CH₂CH(CH₃)O)ᵣ(CH₂CH₂O)_{q}H]₂

where
the subscript “q” may vary from 50 to 400, or alternatively from 100 to 300, and
the subscript “r” may vary from 15 to 75, or alternatively from 20 to 50.

Tetrafunctional poly(oxyethylene)-poly(oxypropylene) block copolymers are commercially available from BASF (Florham Park, N.J.) and are sold under the tradename TETRONIC®. Representative, non-limiting examples suitable as component (B) include; TETRONIC® 908, TETRONIC® 1107, TETRONIC® 1307, TETRONIC® 1508 and TETRONIC® 1504.

The amount of components A) and B) combined in step I) of forming the emulsion are preferably as follows;
100 parts of a silicone gum, and
5 to 100 parts, alternatively 10 to 40 parts, or alternatively 10 to 25 of the ethylene oxide/propylene oxide block copolymer.

In one embodiment, the dispersion formed in step I) consists essentially of components A) and B) as described above. In this embodiment, no additional surfactants or emulsifiers are added in step I). The ethylene oxide/propylene oxide block copolymer is the unique surfactant used. Furthermore, no solvents are added for the purpose of enhancing formation of an emulsion. As used herein, the phrase “essentially free of “solvents” means that solvents are not added to components A) and B) in order to create a mixture of suitable viscosity that can be processed on typical emulsification devices. More specifically, “solvents” as used herein is meant to include any water immiscible low molecular weight organic or silicone material added to the non-aqueous phase of an emulsion for the purpose of enhancing the formation of the emulsion, and is subsequently removed after the formation of the emulsion, such as evaporation during a drying or film formation step. Thus, the phrase “essentially free of solvent” is not meant to exclude the presence of solvent in minor quantities in process or emulsions of the present invention. For example, there may be instances where the components A) and B) may contain minor amounts of solvent as supplied commercially. Small amounts of solvent may also be present from residual cleaning operations in an industrial process. Preferably, the amount of solvent present in the premix should be less than 2% by weight of the mixture, and most preferably the amount of solvent should be less than 1% by weight of the mixture.

The dispersion of step (I) may be prepared by combining components A) and B) and further mixing the components to form a dispersion. The resulting dispersion may be considered as a homogenous mixture of the two components. The present inventors have unexpectedly found that certain ethylene oxide/propylene oxide block copolymers readily disperse with silicone gum compositions, and hence enhance the subsequent formation of emulsion compositions thereof. The present inventors believe other nonionic and/or anionic surfactants, typically known for preparing silicone emulsions, do not form such dispersions or homogeneous mixtures upon mixing with a silicone gum (at least not in the absence of a solvent or other substance to act as a dispersing medium). While not wishing to be limited to any theory, the inventors believe the discovery of the present ethylene oxide/propylene oxide block copolymers to form such dispersions with silicone gums, provides emulsion compositions of silicone gums without the presence of undesirable solvents, or requiring elaborate handling/mixing techniques.

Mixing can be accomplished by any method known in the art to effect mixing of high viscosity materials. The mixing may occur either as a batch, semi-continuous, or continuous process. Mixing may occur, for example using, batch mixing equipments with medium/low shear include change-can mixers, double-planetary mixers, conical-screw mixers, ribbon blenders, double-arm or sigma-blade mixers; batch equipments with high-shear and high-speed dispersers include those made by Charles Ross & Sons (NY), Hockmeyer Equipment Corp. (NJ); batch mixing equipment such as those sold under the tradename Speedmixer®; batch equipments with high shear actions include Banbury-type (CW Brabender Instruments Inc., NJ) and Henschel type (Henschel mixers America, TX). Illustrative examples of continuous mixers/compounders include extruders single-screw, twin-screw, and multi-screw extruders, co-rotating extruders, such as those manufactured by Krupp Werner & Pfleiderer Corp (Ramsey, N.J.), and Leistritz (NJ); twin-screw counter-rotating extruders, two-stage extruders, twin-rotor continuous mixers, dynamic or static mixers or combinations of these equipments.

The process of combining and mixing components A) and B) may occur in a single step or multiple step process. Thus, components A) and B) may be combined in total, and subsequently mixed via any of the techniques described above. Alternatively, a portion(s) of components A) and B) may first be combined, mixed, and followed by combining additional quantities of either or both components and further mixing. One skilled in the art would be able to select optimal portions of components A) and B) for combing and mixing, depending on the selection of the quantity used and the specific mixing techniques utilized to perform step I) to provide a dispersion of components A) and B).

Step II of the process involves admixing sufficient water to the mixture of step I to form an emulsion. Typically 5 to 700 parts water are mixed for every 100 parts of the step I mixture to form an emulsion. In one embodiment the emulsion formed is a water continuous emulsion. Typically, the water continuous emulsion has dispersed particles of the silicone gum from step I, and having an average particle size less than 150 μm.

The amount of water added in step II) can vary from 5 to 700 parts per 100 parts by weight of the mixture from step I. The water is added to the mixture from step I at such a rate so as to form an emulsion of the mixture of step I. While this amount of water can vary depending on the selection of the amount of silicone gum present and the specific ethylene oxide/propylene oxide block copolymer used, generally the amount of water is from 5 to 700 parts per 100 parts by weight of the step I mixture, alternatively from 5 to 100 parts per 100 parts by weight of the step I mixture, or alternatively from 5 to 70 parts per 100 parts by weight of the step I mixture.

Typically the water is added to the mixture from step I in incremental portions, whereby each incremental portion comprises less than 30 weight % of the mixture from step I and each incremental portion of water is added successively to the previous after the dispersion of the previous incremental portion of water, wherein sufficient incremental portions of water are added to form an emulsion.

Alternatively, a portion or all the water used in step I) may be substituted with various hydrophilic solvents that are soluble with water such as low molecular weight alcohols, ethers, esters or glycols. Representative non-limiting examples include low molecular weight alcohols such as methanol, ethanol, propanol, isopropanol and the like; low molecular weight ethers such as di(propyleneglycol) mono methyl ether, di(ethyleneglycol) butyl ether, di(ethyleneglycol) methyl ether, di(propyleneglycol) butyl ether, di(propyleneglycol) methyl ether acetate, di(propyleneglycol) propyl ether, ethylene glycol phenyl ether, propylene glycol butyl ether, 1-methoxy-2-propanol, 1-methoxy-2-propyl acetate, propylene glycol propyl ether, 1-phenoxy-2-propanol, tri(propyleneglycol) methyl ether and tri(propyleneglycol) butyl ether, and other like glycols.

Mixing in step (II) can be accomplished by any method known in the art to affect mixing of high viscosity materials. The mixing may occur either as a batch, semi-continuous, or continuous process. Any of the mixing methods as described for step (I), may be used to affect mixing in step (II). Typically, the same equipment is used to effect mixing in steps I) and II).

Optionally, the water continuous emulsion formed in step (II) may be further sheared according to step (III) to reduce particle size and/or improve long term storage stability. The shearing may occur by any of the mixing techniques discussed above.

The emulsion products resulting from the present process may be an oil/water emulsion, a water/oil emulsion, a multiple phase or triple emulsion.

In one embodiment, the emulsion products produced by the present process are oil/water emulsions. The oil/water emulsion may be characterized by average volume particle of the dispersed silicone gum (oil) phase in a continuous aqueous phase. The particle size may be determined by laser diffraction of the emulsion. Suitable laser diffraction techniques are well known in the art. The particle size is obtained from a particle size distribution (PSD). The PSD can be determined on a volume, surface, length basis. The volume particle size is equal to the diameter of the sphere that has the same volume as a given particle. The term Dv represents the average volume particle size of the dispersed particles. Dv 50 is the particle size measured in volume corresponding to 50% of the cumulative particle population. In other words if Dv 50=10 μm, 50% of the particle have an average volume particle size below 10 μm and 50% of the particle have a volume average particle size above 10 μm. Dv 90 is the particle size measured in volume corresponding to 90% of the cumulative particle population.

The average volume particle size of the dispersed siloxane particles in the oil/water emulsions is between 0.1 μm and 150 μm; or between 0.1 μm and 30 μm; or between 0.3 μm and 5.0 μm.

Silicone gum content of the present emulsion may vary from 0.5 weight percent to 95 weight percent, alternatively from 20 weight percent to 80 weight percent, or alternatively from 40 weight percent to 60 weight percent.

Additional additives and components may also be included in the emulsion compositions, such as preservatives, freeze/thaw additives, and various thickeners.

The invention provides an aqueous solution based method to surface treat fillers which represents a huge plus on an environmental aspect.

The invention can be used to treat polymeric powder with silicone. This permits to transform the surface properties of the polymeric powder to compatibilise it with other polymers for example polypropylene (PP) or polyethylene with polyamide, PP sulfone with PP, PLA (polylactic acid) with PP, PLA with PBT polybutylene terephtalate, acryloxybutylstyrene ABS with PC (polycarbonate).

### EXAMPLES

The following examples are included to demonstrate certain embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. All percentages are in wt. %. All measurements were conducted at 23° C. unless indicated otherwise.

### Example 1

### Emulsification of Silicone Gum Using Pluronic® F-88

First, 15 g of silicone gum (Dow Corning®SGM-36, a hydroxy terminated polydimethylsiloxane) was weighed into a Max 40 cup along with 1.5 g of Pluronic® F-88 nonionic surfactant and 10 g of 3 mm glass beads. The cup was closed and placed inside a DAC-150 SpeedMixer® and the cup was spun at maximum speed (3450 RPM) for 2 minutes. The cup was opened and the mixture, now very warm, had become a creamy white paste that easily flowed when mixed with a spatula. The walls of the cup were scraped with a spatula and the cup was spun again at maximum speed for 1 minute. Then, 0.88 g of water was added to the cup and the cup was spun for 30 seconds at maximum speed. An additional 1.2 g of water was added and the cup was again spun for 30 seconds at maximum speed. Two more water additions were made, one of 2.5 g and the other 3.92 g with the cup being spun for 20 seconds after each water addition. The milky white mixture was now finished and it consisted of an o/w emulsion of silicone gum having a silicone content of 60 percent by weight. Particle size of the emulsion was determined using a Malvern Mastersizer S (version 2.19) and the results were: Dv50=6.93 μm, Dv90=13.24 μm.

### Example 2

### Emulsification of Silicone Resin using Pluronic® F-108

The following were weighed into a Max 100 cup in the following order: 35 g silicone flake resin (Xiameter® RSN-6018 Resin) having a number average molecular weight of 1200 and a specific gravity of 1.25, 16 g of 3 mm spherical glass beads (Fisher) and 7 g of Pluronic® F-108 nonionic surfactant. The cup was closed and placed into a DAC-150 SpeedMixer® and the cup was spun at maximum speed (3450 RPM) for two minutes. The cup was opened and inspected. The mixture, which had become very warm, had taken on a creamy white appearance. The cup was closed and allowed to stand undisturbed for five minutes in order for the mixture to cool slightly. The cup was placed back in the mixer and spun for an additional 1 minute at maximum speed. The mixture was diluted with 28 g of deionized (Dl) water in five increments by adding aliquots of water and spinning the cup for 25 seconds after addition of each aliquot. The increments of water were as follows: 2 g, 3 g, 5 g, 8 g and 10 g. Following the last dilution, the resulting composition consisted of an o/w emulsion of silicone resin having a silicone content of 50 percent by weight. Particle size of the emulsion was measured using a Malvern® Mastersizer 2000 and found to be: Dv50=0.56 μm; Dv90=0.94 μm.

1. A substrate in powder or fibre form whose surface is treated with a silicone compound, wherein the surface has been treated with an emulsion containing the silicone compound, water and an ethylene oxide/propylene oxide block copolymer.

2. The substrate of claim 1, wherein the substrate is a filler, fibre, pigment, metallic or mineral powder.

3. The substrate of claim 1, wherein the substrate is an organic powder or a fibre.

4. The substrate of claim 1 wherein the silicone compound is functionalized.

5. The substrate of claim 1, wherein the silicone compound contains hydroxyl, amino, unsaturations or alkoxy functions.

6. The substrate of claim 1 wherein the silicone compound is a silicone gum or a silicone resin.

7. The substrate of claim 1 wherein the silicone compound has a kinetic viscosity greater than one million cSt at 25° C.

8. The substrate of claim 1 wherein the silicone compound is polydimethylsiloxane having a viscosity of at least 500 thousand cP at 0.01 Hz at 25° C.

9. The substrate of claim 1 wherein the ethylene oxide/propylene oxide block copolymer is a poly(oxyethylene)-poly(oxypropylene)-poly(oxyethylene) tri-block copolymer having the formula;
HO(CH₂CH₂O)ₘ(CH₂CH(CH₃)O)(CH₂CH₂O)ₘH
where
m is in the range of from 50 to 400, and
n is in the range of from 20 to 100.

10. The substrate of claim 1 wherein the ethylene oxide/propylene oxide block copolymer is a tetrafunctional poly(oxyethylene)-poly(oxypropylene) block copolymer having the average formula;
[HO(CH₂CH₂O)_{q}(CH₂CH(CH₃)O)ᵣ]₂NCH₂CH₂N[(CH₂CH(CH₃)O)ᵣ(CH₂CH₂O)_{q}H]₂
where
q is in the range of from 50 to 400, and
r is in the range of from 15 to 75.

11. A process for forming a surface treated substrate in powder or fibre form comprising applying an emulsion comprising a silicone compound, an ethylene oxide/propylene oxide block copolymer and water onto the surface of the substrate.

12. A method of improving mechanical properties, optical properties, processing, or flame retardancy of a matrix, the method comprising incorporating into the matrix a substrate in powder form whose surface has been treated with an emulsion comprising a silicone compound, water and an ethylene oxide/propylene oxide, whereby mechanical properties, optical properties, processing, or flame retardancy of the matrix is improved by the incorporating step.

13. The method according to claim 12, wherein the matrix is a thermoplastic, thermoset, rubber or combinations thereof.

14. A process of treating the surface of a substrate in powder or fibre form comprising applying an emulsion comprising a silicone compound, water and an ethylene oxide/propylene oxide block copolymer to the surface of the substrate in powder or fibre form.

15. The substrate of claim 3, wherein the substrate is an organic powder and the organic powder is powdery polypropylene.

16. The substrate of claim 3, wherein the substrate is a fibre and the fibre is tetrafluoroethylene.
